(19) United States
(12) Patent Application Publication
(10) Pub. No.: US 2001/0007473 A1
(43) Pub. Date: Jul. 12, 2001

(54) Imaging method and apparatus for generating an output image with a wide dynamic range

(75) Inventors: Charles Chuang, Taipei Hsien (TW); Chun-Hung Wen, Taipei Hsien (TW)

Correspondence Address: Marchant & Gould P.C., P.O. Box 2903, Minneapolis, MN, 55402-0903, US

(73) Assignee: Dynacolor, Inc.

(21) Appl. No.: 09/757,671

(22) Filed: Jan. 10, 2001

(30) Foreign Application Priority Data
Jan. 10, 2000 (TW) 089100199

(51) Int. Cl. H04N 5/235

(52) U.S. Cl. 348/362; 348/229

(57) ABSTRACT

In an imaging method and apparatus for generating an enhanced optical image of a scene, input optical image signals are generated by sensing an optical image input of the scene at a single exposure, the optical image input having a wide input dynamic range with a plurality of dynamic range portions. The input optical image signals are subsequently processed to obtain a plurality of optical image data during the single exposure, wherein the optical image data have dynamic ranges that correspond respectively to the dynamic range portions. Thereafter, the optical image data are combined to result in optical image output data corresponding to the enhanced optical image of the scene.

### BACKGROUND OF THE INVENTION

1. Field of the Invention

The invention relates to an imaging method and apparatus, more particularly to an imaging method and apparatus for generating an output image with a wide dynamic range.

2. Description of the Related Art

In a conventional imaging apparatus, such as a motion video camera or a still image camera, a light level coordinate of 1 indicates the lowest light level that can be detected and that is barely above the noise floor, whereas a light level coordinate of 4096 indicates the highest light level that can be detected and that is just at the brink of saturation. In other words, the widest dynamic range of a conventional imaging apparatus, which is defined as the ratio between the highest and lowest light levels that can be detected, is 4096:1. In binary form, 12 bits are needed to represent the full range of the light level coordinates. However, image output devices that are capable of processing 12-bit light level coordinates are very expensive as compared to those capable of processing 8-bit light level coordinates due to their high precision requirement. As such, scaling down of the 12-bit light level coordinates to 8 bits is usually performed to avoid the need for using expensive image output devices.

On the other hand, scaling down of the 12-bit light level coordinates to 8 bits results in a reduction of the output dynamic range from 4096:1 to 256:1. The effect of the reduction in the output dynamic range will be explained in greater detail via the following example.

FIG. 1(a) illustrates a histogram analysis of an image output prepared according to the pixel data that constitute the image output and their corresponding light level coordinates, and under the assumption that an ideal imaging apparatus can capture and produce the entire wide dynamic range of light level coordinates. The X-axis of the histogram represents the 4096 light level coordinates, whereas the Y-axis of the histogram shows the number of pixel data associated with each of the 4096 light level coordinates. It is evident that the image output of FIG. 1(a) has a low light level portion and a high light level portion. The dynamic range of this image output is beyond the control range of a conventional imaging apparatus.

FIG. 1(b) illustrates a histogram analysis of the same image output produced by a conventional imaging apparatus, wherein the 4096 light level coordinates are scaled down to 256. In the histogram of FIG. 1(b), the imaging apparatus has a back light compensation feature to overexpose a scene so that details in the low light level portion can be reproduced. However, the high light level portion is saturated, and details therein are lost, as indicated at the rightmost end of the histogram.

FIG. 1(c) illustrates a histogram analysis of the same image output produced by a conventional imaging apparatus using standard auto exposure control, wherein the 4096 light level coordinates are also scaled down to 256. In the histogram of FIG. 1(c), details in the high light level portion can be reproduced, but details in the low light level portion are lost, as indicated at the leftmost end of the histogram.

In U.S. Pat. No. 5,144,442, there is disclosed a wide dynamic range video imaging apparatus. In this patent, a timing controller controls the duration of the exposure time of a camera so that a plurality of video images of a scene at different exposure levels can be obtained. An analog-to-digital converter converts the video images into digital video data, and a neighborhood transform processor performs neighborhood transform processing upon the video data. A combiner combines the processed video data to result in a combined video image that is stored in a memory device.

A main drawback of the aforesaid video imaging apparatus resides in that multiple exposures of the same scene are required to generate the combined video image. As such, the technique is only applicable to video with very slow moving objects because images from two different exposures taken at different time intervals are combined. This technique is not applicable to fast moving objects where fast exposure times are required to generate clear images. Further, full frame buffers are required for storage of the video data taken at different exposure levels so that combining of the video images can proceed, thereby resulting in a relatively large memory requirement. If multiple cameras are to be employed so as to generate the plurality of video images of the scene at different exposure levels and at the same time, the size and cost of the video imaging apparatus will be considerably increased.

### SUMMARY OF THE INVENTION

Therefore, the object of the present invention is to provide an imaging method and apparatus for generating an output image with a wide dynamic range without requiring multiple exposures and a relatively large memory space for video data.

According to one aspect of the invention, an imaging method for generating an enhanced optical image of a scene comprises the steps of:

generating at least first and second optical image data corresponding to an optical image input of the scene taken at a single exposure, the optical image input having a wide input dynamic range with at least higher and lower dynamic range portions, the higher dynamic range portion having an upper range limit that serves as an upper range limit of the wide input dynamic range, the lower dynamic range portion having a lower range limit that is lower than the upper range limit of the higher dynamic range portion and that serves as a lower range limit of the wide input dynamic range, the first optical image data having a dynamic range corresponding to the higher dynamic range portion, the second optical image data having a dynamic range corresponding to the lower dynamic range portion; and

combining the first and second optical image data to result in optical image output data corresponding to the enhanced optical image of the scene.

According to another aspect of the invention, an imaging apparatus for generating an enhanced optical image of a scene comprises:

an image generating device for generating at least first and second optical image data corresponding to an optical image input of the scene taken at a single exposure, the optical image input having a wide input dynamic range with at least higher and lower dynamic range portions, the higher dynamic range portion having an upper range limit that serves as an upper range limit of the wide input dynamic range, the lower dynamic range portion having a lower range limit that is lower than the upper range limit of the higher dynamic range portion and that serves as a lower range limit of the wide input dynamic range, the first optical image data having a dynamic range corresponding to the higher dynamic range portion, the second optical image data having a dynamic range corresponding to the lower dynamic range portion; and

an image combining device, coupled to the image generating device, for combining the first and second optical image data to result in optical image output data corresponding to the enhanced optical image of the scene.

### BRIEF DESCRIPTION OF THE DRAWINGS

Other features and advantages of the present invention will become apparent in the following detailed description of the preferred embodiments with reference to the accompanying drawings, of which:

FIG. 1(a) illustrates a histogram analysis of an image output prepared according to the pixel data that constitute the image output and their corresponding light level coordinates, and under the assumption that an ideal imaging apparatus can capture and produce the entire wide dynamic range of light level coordinates;

FIG. 1(b) illustrates a histogram analysis of the same image output produced by a conventional imaging apparatus having a back light compensation feature to overexpose a scene so that details in the low light level portion can be reproduced;

FIG. 1(c) illustrates a histogram analysis of the same image output produced by a conventional imaging apparatus using standard auto exposure control;

FIG. 2 is a schematic circuit block diagram illustrating the first preferred embodiment of an imaging apparatus according to the present invention;

FIG. 3 shows a series of histograms to illustrate the operation of the first preferred embodiment;

FIG. 4 is a schematic circuit block diagram illustrating the second preferred embodiment of an imaging apparatus according to the present invention;

FIG. 5 shows a histogram to illustrate how a wide input dynamic range is segregated into higher and lower dynamic range portions in the second preferred embodiment;

FIG. 6 is a schematic circuit block diagram illustrating the third preferred embodiment of an imaging apparatus according to the present invention;

FIG. 7 shows a histogram to illustrate how a wide input dynamic range is segregated into a plurality of dynamic range portions in the third preferred embodiment; and

FIG. 8 shows a histogram to illustrate how a wide input dynamic range is segregated into a plurality of dynamic range portions in the fourth preferred embodiment of an imaging apparatus according to the present invention.

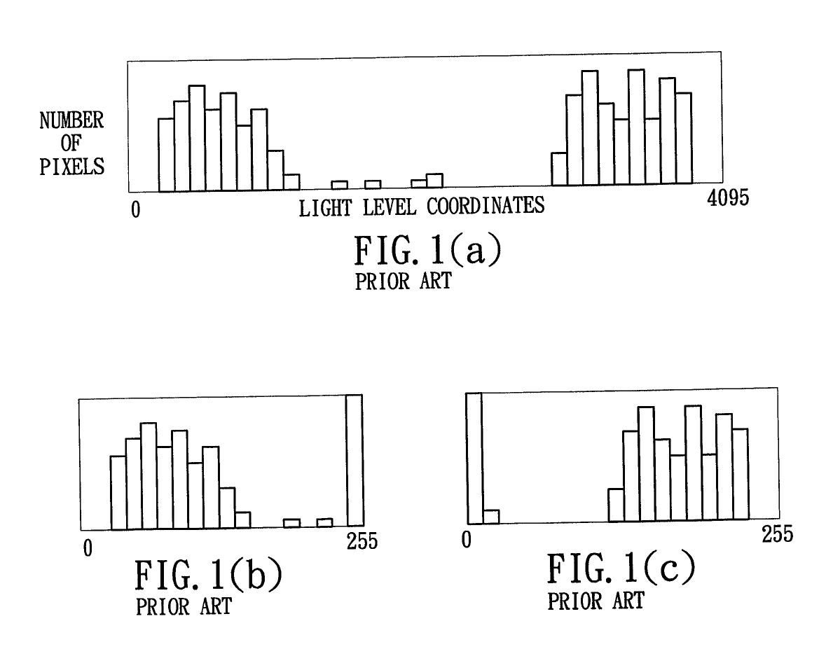

### DETAILED DESCRIPTION OF THE PREFERRED EMBODIMENTS

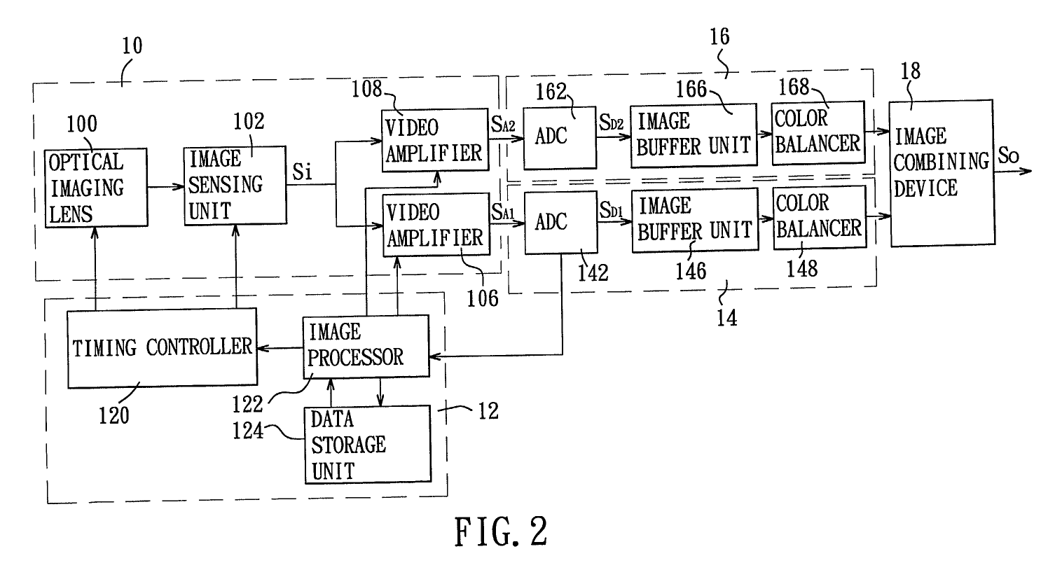

Referring to FIG. 2, the first preferred embodiment of an imaging apparatus according to the present invention is shown to comprise an image generating device that includes an image capturing unit 10 and a pair of signal converters 14, 16, a control device 12, and an image combining device 18. In this embodiment, the image capturing unit 10 includes an optical imaging lens 100, an image sensing unit 102, and two video amplifiers 106, 108. The control device 12 includes a timing controller 120, an image processor 122, such as a digital signal processor (DSP), and a data storage unit 124. Each of the signal converters 14, 16 is associated with a respective one of the video amplifiers 106, 108, and includes an analog-to-digital converter (ADC) 142, 162, and an image buffer unit 146, 166.

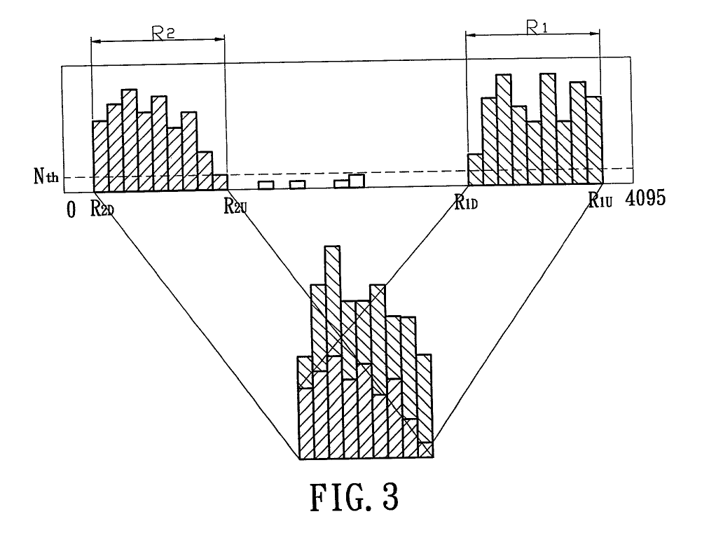

In use, the imaging apparatus will initially operate in a set-up mode. At this time, the optical imaging lens 100 will generate an optical image input of a scene. The image sensing unit 102, such as a CCD, CID, CMOS, photodiode array, or any other visible or non-visible light sensor array, is coupled to the optical imaging lens 100, and receives the optical image input therefrom. The timing controller 120, which comprises conventional clocks, counters and frequency dividers, is coupled to the image sensing unit 102, and controls the integration time of the same in a known manner. The image sensing unit 102 consists of an array of pixel sensing cells, and generates input optical image signals corresponding to the optical image input sensed thereby. In the set-up mode, the video amplifier 106, which is coupled to the image sensing unit 102, amplifies the input optical image signals from the image sensing unit 102. The ADC 142, which is coupled to the video amplifier 106, receives the output of the latter, and proceeds to convert the same into optical image data. The optical image data from the ADC 142 is received by the image processor 122, which is coupled to the ADC 142. Thereafter, the image processor 122 analyzes the light level coordinate distribution of image pixel data that constitute the optical image data from the ADC 142. Based on the light level coordinate distribution analyzed thereby, for light level coordinates distributed with a number of image pixel data that is above a predetermined light level threshold number (Nₜₕ), the image processor 122 determines an upper range limit (R_{1U}) of a higher dynamic range portion (R₁) of a wide input dynamic range of the optical image input, and a lower range limit (R_{2D}) of a lower dynamic range portion (R₂) of the wide input dynamic range of the optical image input, as shown in FIG. 3. The upper range limit (R_{1U}) of the higher dynamic range portion (R₁) is the largest light level coordinate distributed with a number of the image pixel data that is above the predetermined light level threshold number (Nₜₕ), and is also the upper range limit of the wide input dynamic range of the optical image input. The lower range limit (R_{2D}) of the lower dynamic range portion (R₂) is the smallest light level coordinate distributed with a number of the image pixel data that is above the predetermined light level threshold number (Nₜₕ), and is also the lower range limit of the wide input dynamic range of the optical image input. The image processor 122 then determines a lower range limit (R_{1D}) of the higher dynamic range portion (R₁), and an upper range limit (R_{2U}) of the lower dynamic range portion (R₂) such that a total number of the image pixel data having light levels that fall in either one of the higher and lower dynamic range portions (R₁, R₂) is greater than a predetermined pixel threshold number, e.g. 90% or more of the total number of image pixel data from the ADC 142.

The higher and lower dynamic range portions (R₁, R₂) do not overlap. If the total number of the image pixel data having light levels that fall in either one of the higher and lower dynamic range portions (R₁, R₂) is less than the predetermined pixel threshold number, the light level threshold number (Nₜₕ) is decreased, and the upper and lower range limits (R_{1U}, R_{2U}, R_{1D}, R_{2D}) of the higher and lower dynamic range portions (R₁, R₂) are determined anew in the manner described hereinabove. As such, the condition that the total number of the image pixel data having light levels that fall in either one of the higher and lower dynamic range portions (R₁, R₂) is greater than the predetermined pixel threshold number can be fulfilled. In addition, image pixel data having light levels that do not fall in either one of the higher and lower dynamic range portions (R₁, R₂) can be adjusted to the lower range limit (R_{1D}) of the higher dynamic range portion (R₁) or the upper range limit (R_{2U}) of the lower dynamic range portion (R₂).

Upon determining the range limits of the higher and lower dynamic range portions (R₁, R₂), the image processor 122 stores range information associated with the higher and lower dynamic range portions (R₁, R₂) in the data storage unit 124.

After operation in the set-up mode, the imaging apparatus is now ready for operation in an output image-generating mode. In the output image-generating mode, the optical imaging lens 100 will generate an optical image input of a scene. The image sensing unit 102 receives the optical image input from the optical imaging lens 100 and, under the control of the timing controller 120, generates input optical image signals (Sᵢ) corresponding to the optical image input sensed thereby. The input optical image signals (Sᵢ) are provided to the video amplifiers 106, 108, simultaneously. Based on the range information stored in the data storage unit 124, the bias and gain settings of the video amplifiers 106, 108 are adjusted by the image processor 122 such that the optical image signal output (S_{A1}) of the video amplifier 106 has a dynamic range corresponding to the higher dynamic range portion (R₁), and such that the optical image signal output (S_{A2}) of the video amplifier 108 has a dynamic range corresponding the lower dynamic range portion (R₂). Particularly, the video amplifier 106 processes the input optical image signals (Sᵢ) such that the input optical image signals (Sᵢ) that are encompassed by the higher dynamic range portion (R₁) will fall within the operating range of the ADC 142, which is coupled to the video amplifier 106. The video amplifier 108 processes the input optical image signals (Sᵢ) such that the input optical image signals (Sᵢ) that are encompassed by the lower dynamic range portion (R₂) will fall within the operating range of the ADC 162, which is coupled to the video amplifier 108. The ADC 142 receives the signal output (S_{A1}) of the video amplifier 106, and proceeds to convert the same into 8-bit optical image data (S_{D1}) that is stored in the image buffer unit 146. The ADC 162 receives the signal output (S_{A2}) of the video amplifier 108, and proceeds to convert the same into 8-bit optical image data (S_{D2}) that is stored in the image buffer unit 166. The image buffer units 146, 166 are preferably line buffers to minimize memory costs.

The image combining device 18, which is coupled to the image buffer units 146, 166, retrieves the optical image data (S_{D1}, S_{D2}) from the same. The image combining device 18 combines the optical image data (S_{D1}, S_{D2}) to obtain optical image output data (Sₒ) corresponding to an enhanced optical image of the scene. As to how the optical image data (S_{D1}, S_{D2}) are combined by the image combining device 18, this can be accomplished in different ways. For example, the optical image data (S_{D2}) corresponding to the lower dynamic range portion (R₂) can be scaled to 0-127th levels, whereas the optical image data (S_{D1}) corresponding to the higher dynamic range portion (R₁) can be scaled to 128-255th levels. Alternatively, the 0-255th levels can be divided according to the ratio of the ranges of the higher and lower dynamic range portions (R₁, R₂). The optical image output data (So) from the image combining device 18 may undergo additional processing, such as edge enhancement, histogram equalization, compression logic, and encoding logic, before being provided to an image output device (not shown).

It should be understood that it is not necessary to operate the imaging apparatus in the set-up mode each time an output image is to be generated. Operation in the set-up mode can be initiated automatically after a period of time, in cases where the target object of successive output images remains still, and where there is little change in the lighting conditions of successive output images. Conventional techniques can be employed to detect changes in the target object or the lighting conditions for alerting the user of the need to operate the imaging apparatus in the set-up mode at appropriate times.

Through the use of the video amplifiers 106, 108 and the ADCs 142, 162, the control range of the imaging apparatus of this invention can be broadened to cover an inherently wide dynamic range that is beyond that which can be achieved through the use of a single video amplifier-and-ADC pair.

In the embodiment of FIG. 2, the optical imaging lens 100 is of an electronic shutter type, and is coupled to and controlled by the timing controller 120 in a known manner. Alternatively, the optical imaging lens 100 can be replaced by a mechanical shutter type that is manually operated to control the provision of the optical image input to the image sensing unit 102.

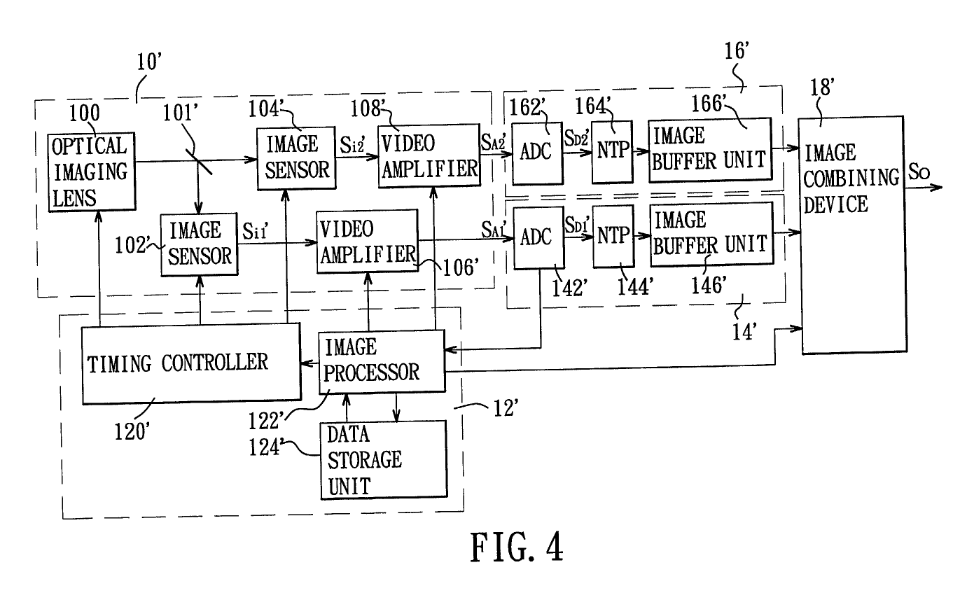

Referring to FIG. 4, the second preferred embodiment of an imaging apparatus according to the present invention is shown to also comprise an image generating device that includes an image capturing unit 10′ and a pair of signal converters 14′, 16′, a control device 12′, and an image combining device 18′. In this embodiment, the image capturing unit 10′ includes an optical imaging lens 100′, an image splitter 101′, two image sensors 102′, 104′, and two video amplifiers 106′, 108′. The control device 12′ includes a timing controller 120′, an image processor 122′, and a data storage unit 124′. Each of the signal converters 14′, 16′ is associated with a respective one of the video amplifiers 106′, 108′, and includes an analog-to-digital converter (ADC) 142′, 162′, a neighborhood transform processor (NTP) 144′, 164′, and an image buffer unit 146′, 166′.

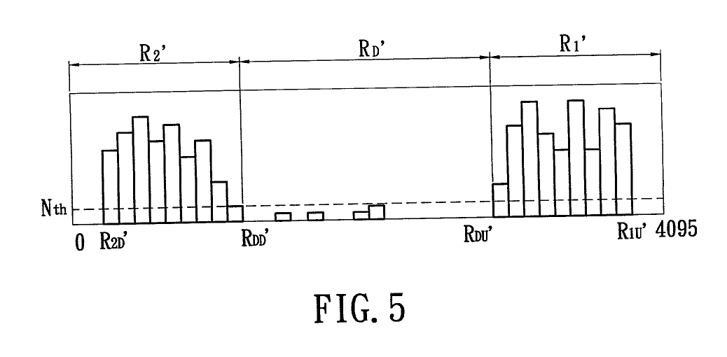

In use, the imaging apparatus will initially operate in a set-up mode. At this time, the optical imaging lens 100′ will generate an optical image input of a scene. The image splitter 101′, which couples optically the optical imaging lens 100′ to the image sensors 102′, 104′, will split the optical image input from the optical imaging lens 100′ and will provide split optical image inputs to the image sensors 102′, 104′. The image sensors 102′, 104′ generate input optical image signals (S_{i1′}, S_{i2′}) corresponding to the optical image inputs sensed thereby. In the set-up mode, the video amplifier 106′, which is coupled to the image sensor 102′, amplifies the input optical image signals (S_{i1′}) therefrom. The ADC 142′, which is coupled to the video amplifier 106′, receives the optical image signal output (S_{A1′}) of the latter, and proceeds to convert the same into digital form. The optical image data (S_{D1′}) from the ADC 142′ is received by the image processor 122′. Thereafter, the image processor 122′ analyzes the light level coordinate distribution of image pixel data that constitute the optical image data (S_{D1′}) from the ADC 142′. Based on the light level coordinate distribution analyzed thereby, for light level coordinates distributed with a number of image pixel data that is above a predetermined light level threshold number (Nₜₕ), the image processor 122′ determines an upper range limit (R_{1U′}) of a wide input dynamic range of the optical image input, and a lower range limit (R_{2D′}) of the wide input dynamic range of the optical image input in a manner similar to that of the previous embodiment, as shown in FIG. 5.

The image processor 122′ then determines a non-significant dynamic range portion (R_{D′}) between the upper and lower range limits (R_{1U′}), (R_{2D′}). The non-significant dynamic range portion (R_{D′}) is a dynamic range portion of the wide input dynamic range of the optical image input that encompasses a greatest number of consecutive light level coordinates distributed with a number of image pixel data that is below the predetermined light level threshold number (Nₜₕ). Thereafter, the image processor 122′ assigns an upper range limit of the non-significant dynamic range portion (R_{D′}) as a lower range limit (R_{DU′}) of a higher dynamic range portion (R_{1′}) of the wide input dynamic range of the optical image input, and a lower range limit of the non-significant dynamic range portion (R_{D′}) as an upper range limit (R_{DD′}) of a lower dynamic range portion (R_{2′}) of the wide input dynamic range of the optical image input.

In the second preferred embodiment, in cases when the total number of image pixel data having light levels that fall in either one of the higher and lower dynamic range portions (R_{1′}, R_{2′}) fails to encompass a predetermined pixel threshold number, e.g. 90% or more of the total number of image pixel data from the ADC 142′, the image processor 122′ adjusts the predetermined light level threshold number (Nₜₕ) to reduce the number of non-significant light level coordinates in the light level coordinate distribution analyzed by the image processor 122′. The image processor 122′ then determines a new non-significant dynamic range portion (R_{D′}) based on the adjusted light level threshold number (Nₜₕ). Adjustment of the light level threshold number (Nₜₕ) is repeated until the total number of image pixel data having light levels that fall in either one of the higher and lower dynamic range portions (R_{1′}, R_{2′}) encompasses the predetermined pixel threshold number.

Like the previous embodiment, upon determining the range limits of the higher and lower dynamic range portions (R_{1′}, R_{2′}),the image processor 122′ stores range information associated with the higher and lower dynamic range portions (R_{1′}, R_{2′}) in the data storage unit 124′.

After operation in the set-up mode, the imaging apparatus is now ready to be operated in an output image-generating mode. In the output image-generating mode, the optical imaging lens 100′ will provide an optical image input of a scene. The image splitter 101′ splits the optical image input from the optical imaging lens 100′, and provides the split optical image inputs to the image sensors 102′, 104′, respectively. At this time, according to the range information stored in the data storage unit 124′, the image processor 122′ controls the timing controller 120′ to vary, in turn, the integration times of the image sensors 102′, 104′. The purpose of varying the integration times is to provide an effect similar to the adjustment of the gain settings of the video amplifiers 106, 108 of the imaging apparatus of the first preferred embodiment. The image sensors 102′, 104′ generate input optical image signals (S_{i1′}, S_{i2′}) corresponding to the split optical image inputs sensed thereby. The input optical image signals (S_{i1′}, S_{i2′}) are provided to the video amplifiers 106′, 108′, simultaneously. Based on the range information stored in the data storage unit 124′, the bias settings of the video amplifiers 106′, 108′ are further adjusted by the image processor 122′ such that the optical image signal output (S_{A1′}) of the video amplifier 106′ has a dynamic range corresponding to the higher dynamic range portion (R_{1′}) of the wide input dynamic range of the optical image input, and such that the optical image signal output (S_{A2′}) of the video amplifier 108′ has a dynamic range corresponding to the lower dynamic range portion (R_{2′}) of the wide input dynamic range of the optical image input. Particularly, the video amplifier 106′ processes the input optical image signals (S_{i1′}) such that the optical image signals (S_{i1′}) that are encompassed by the higher dynamic range portion (R_{1′}) will fall within the operating range of the ADC 142′. The video amplifier 108′ processes the input optical image signals (S_{i2′}) such that the optical image signals (S_{i2′}) that are encompassed by the lower dynamic range portion (R_{2′}) will fall within the operating range of the ADC 162′. The ADC 142′ receives the optical image signal output (S_{A1′}) of the video amplifier 106′, and proceeds to convert the same into 8-bit optical image data (S_{D1′}) The ADC 162′ receives the optical image signal output (S_{A2′}) of the video amplifier 108′, and proceeds to convert the same into 8-bit optical image data (S_{D2′}).

The NTPs 144′, 164′ are coupled to the ADCs 142′, 162′, and receive the optical image data (S_{D1′}, S_{D2′}) therefrom, respectively. The NTPs 144′, 164′ perform known neighborhood transform processing upon the optical image data (S_{D1′}, S_{D2′}) to reduce low frequency components and to achieve edge and contrast enhancement. The processed image data from the NTPs 144′, 164′, are stored in the image buffer units 146′, 166′. In this embodiment, the image buffer units 146′, 166′ are line buffers, the sizes of which depend on the neighborhood transform algorithm.

The image combining device 18′, which is coupled to the image buffer units 146′, 166′, retrieves the transformed image data from the same. The image combining device 18′ combines the transformed image data retrieved thereby in a manner similar to that of the image combining device 18 of the first preferred embodiment to obtain optical image output data corresponding to an enhanced optical image of the captured scene.

Unlike the previous embodiment, the image processor 122′ is further coupled to the image combining device 18′ so as to provide the range information of the higher and lower dynamic range portions (R_{1′}, R_{2′}) of the wide input dynamic range thereto. The optical image output data from the image combining device 18′ can include attribute information to permit reconstruction of the transformed image data therefrom.

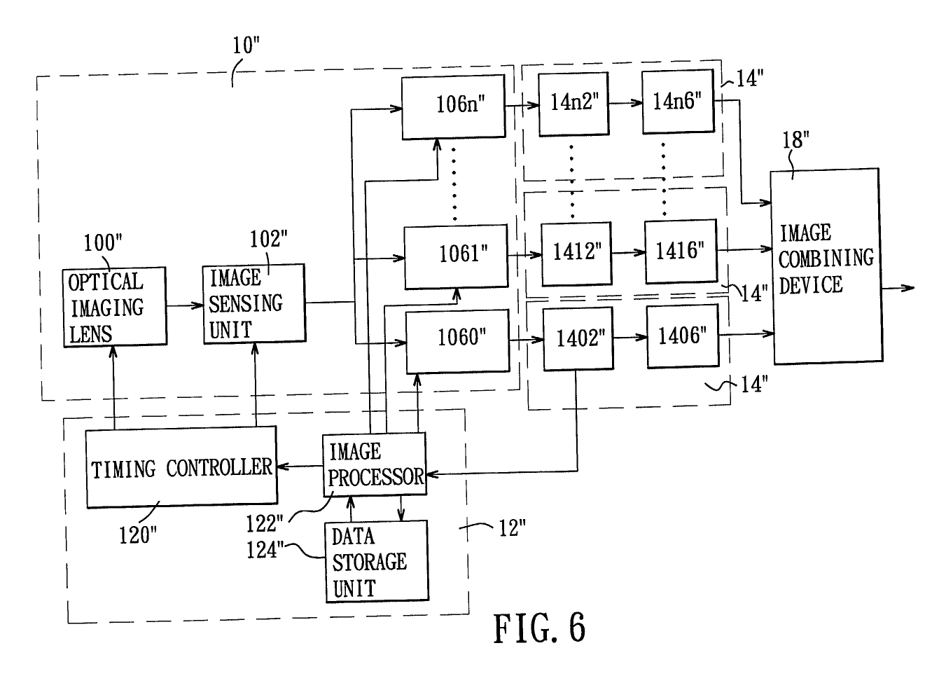

In actual practice, the light level coordinate distribution of the wide input dynamic range of an optical image input can be segregated into more than two dynamic range portions. Referring to FIG. 6, the third preferred embodiment of an imaging apparatus according to the present invention is shown to comprise an image generating device that includes an image capturing unit 10″ and a plurality (up to 10) of signal converters 14″, a control device 12″, and an image combining device 18″. The image capturing unit 10″ includes an optical imaging lens 100″, an image sensing unit 102″, and a plurality (up to 10) of video amplifiers 1060″, 1061″, . . . 106n″. The control device 12″ includes a timing controller 120″, an image processor 122″, and a data storage unit 124″. Each of the signal converters 14″ is associated with a respective one of the video amplifiers 1060″, 1061″, . . . 106n″, and includes an analog-to-digital converter (ADC) 1402″, 1412″, . . . 14n2″, and an image buffer unit 1406″, 1416″, . . . 14n6″.

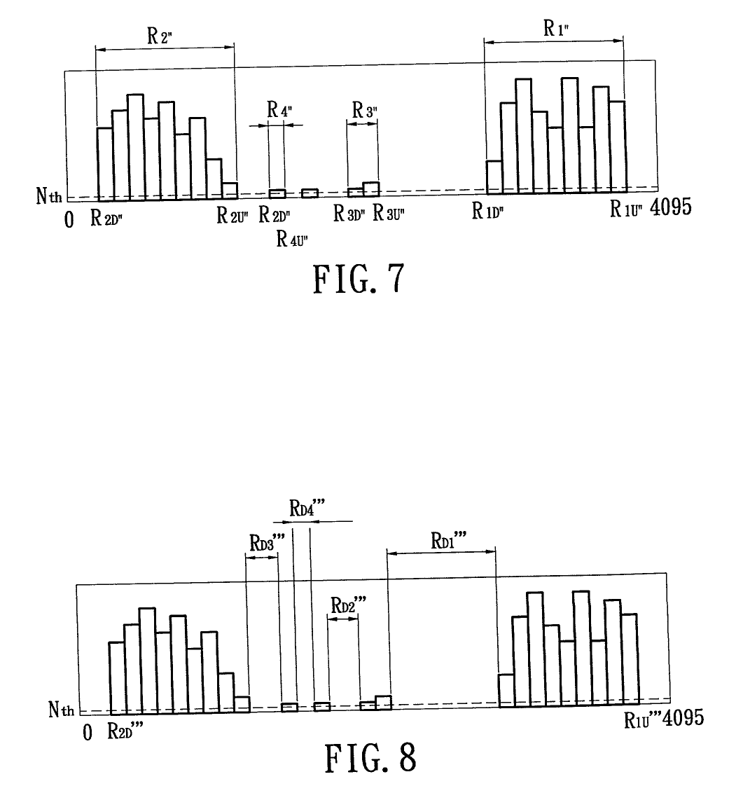

In use, the imaging apparatus will initially operate in a set-up mode. At this time, the optical imaging lens 100″ will provide an optical image input of a scene. The image sensing unit 102″ receives the optical image input from the optical imaging lens 100″. The timing controller 120″ is coupled to the image sensing unit 102″, and controls the integration time of the same in a known manner. The image sensing unit 102″ generates input optical image signals corresponding to the optical image input sensed thereby. In the set-up mode, the video amplifier 1060″ amplifies the input optical image signals from the image sensing unit 102″. The ADC 1402″, which is coupled to the video amplifier 1060″, receives the optical image signal output of the latter, and proceeds to convert the same into digital form. The optical image data from the ADC 1402″ is received by the image processor 122′. Thereafter, the image processor 122″ analyzes the light level coordinate distribution of image pixel data that constitute the optical image data from the ADC 1402″. Based on the light level coordinate distribution analyzed thereby, for light level coordinates distributed with a number of image pixel data that is above a predetermined light level threshold number (Nₜₕ), the image processor 122″ determines an upper range limit (R_{1U″}) of a highest dynamic range portion (R_{1″}) of a wide input dynamic range of the optical image input, and a lower range limit (R_{2D″}) of a lowest dynamic range portion (R_{2″}) of the wide input dynamic range of the optical image input, as shown in FIG. 7. The image processor 122″ then determines a lower range limit (R_{1D″}) of the highest dynamic range portion (R_{1″}) by inspecting successive ones of the light level coordinates in a descending order starting from the upper range limit (R_{1U″}) until a light level coordinate distributed with a number of image pixel data that is below the predetermined light level threshold number (Nₜₕ) is detected. The image processor 122″ further determines an upper range limit (R_{2U″}) of the lowest dynamic range portion (R_{2″}) by inspecting successive ones of the light level coordinates in an ascending order starting from the lower range limit (R_{2D″}) until a light level coordinate distributed with a number of image pixel data that is below the predetermined light level threshold number (Nₜₕ) is detected.

In the event that the total number of image pixel data having light levels that fall in either one of the highest and lowest dynamic range portions (R_{1″}, R_{2″}) fails to encompass a predetermined pixel threshold number, e.g. 90% or more of the total number of image pixel data from the ADC 142″, for light level coordinates distributed with a number of image pixel data that is above the predetermined light level threshold number (Nₜₕ) and not belonging to the highest and lowest dynamic range portions (R_{1″}, R_{2″}), the image processor 122″ then determines an upper range limit (R_{3U″}) of a second-highest dynamic range portion (R_{3″}) of the wide input dynamic range of the optical image input, and a lower range limit (R_{4D″}) of a second-lowest dynamic range portion (R_{4″}) of the wide input dynamic range of the optical image input, as shown in FIG. 7. The image processor 122″ subsequently determines a lower range limit (R_{3D″}) of the second-highest dynamic range portion (R_{3″}) by inspecting successive ones of the light level coordinates in a descending order starting from the upper range limit (R_{3U″}) until a light level coordinate distributed with a number of image pixel data that is below the predetermined light level threshold number (Nₜₕ) is detected. The image processor 122″ further determines an upper range limit (R_{4U″}) of the second-lowest dynamic range portion (R_{4″}) by inspecting successive ones of the light level coordinates in an ascending order starting from the lower range limit (R_{4D″}) until a light level coordinate distributed with a number of image pixel data that is below the predetermined light level threshold number (Nₜₕ) is detected. Whether or not third-highest, third-lowest, fourth-highest, fourth-lowest, fifth-highest and fifth-lowest dynamic range portions are to be determined by the image processor 122″ depends on whether the total number of image pixel data having light levels that fall in any determined one of the dynamic range portions of the wide input dynamic range of the optical image input encompasses the predetermined pixel threshold number. In the example of FIG. 7, the total number of image pixel data in the highest, second-highest, lowest and second-lowest dynamic range portions encompasses the predetermined pixel threshold number, and there is no need to determine the range limits of the third-highest, third-lowest, fourth-highest, fourth-lowest, fifth-highest and fifth-lowest dynamic range portions.

Upon determining the range limits of the different dynamic range portions (R_{1″}, R_{2″}, R_{3″}, R_{4″}, . . . etc.), the image processor 122″ stores range information associated with the different dynamic range portions (R_{1″}, R_{2″}, R_{3″}, R_{4″}, . . . etc.) in the data storage unit 124.

After operation in the set-up mode, the imaging apparatus is now ready to be operated in an output image-generating mode. In the output image-generating mode, the optical imaging lens 100″ will provide an optical image input of a scene. The image sensing unit 102″ receives the optical image input from the optical imaging lens 100″ and, under the control of the timing controller 120″, generates input optical image signals corresponding to the optical image sensed thereby. The input optical image signals are provided to the video amplifiers 1060″, 1061″, . . . 106n″ simultaneously. Based on the range information stored in the data storage unit 124″, the bias and gain settings of the video amplifiers 1060″, 1061″, . . . 106n″ are adjusted by the image processor 122″ such that the output of the video amplifier 1060″ has a dynamic range corresponding to the highest dynamic range portion (R_{1″}), such that the output of the video amplifier 1061″ has a dynamic range corresponding to the second-highest dynamic range portion (R_{3″}), such that the output of the video amplifier 1062″ has a dynamic range corresponding to the second-lowest dynamic range portion (R_{4″}), and such that the output of the video amplifier 1063″ has a dynamic range corresponding to the lowest dynamic range portion (R_{2″}). The operations of the ADCs 1402″, 1412″, . . . 14n2″, the image buffer units 1406″, 1416″, 14n6″, and the image combining device 18″ are similar to those of the ADCs 142, 162, the image buffer units 146, 166 and the image combining device 18 of the first preferred embodiment, and will not be detailed further for the sake of brevity.

The fourth preferred embodiment of an imaging apparatus according to the present invention has a structure similar to that of the third preferred embodiment, the main difference residing in how the image processor 122″ (see FIG. 6) of the fourth preferred embodiment segregates the wide input dynamic range of an optical image input into the different dynamic range portions.

In the fourth preferred embodiment, when the imaging apparatus is operated in the set-up mode, the image processor 122″ analyzes the light level coordinate distribution of image pixel data that constitute the optical image data received thereby. Based on the light level coordinate distribution analyzed thereby, for light level coordinates distributed with a number of image pixel data that is above a predetermined light level threshold number (Nₜₕ), the image processor 122″ determines an uppermost range limit (R_{1U″′}) of the wide input dynamic range of the optical image input, and a lowermost range limit (R_{2D″′}) of the wide input dynamic range of the optical image input, as shown in FIG. 8. The image processor 122″ then determines a first non-significant dynamic range portion (R_{D1″′}) between the uppermost and lowermost range limits (R_{1U″′}), (R_{2D″′}). The first non-significant dynamic range portion (R_{D1″′}) is a dynamic range portion of the wide input dynamic range of the optical image input that encompasses a greatest number of consecutive light level coordinates distributed with a number of image pixel data that is below the predetermined light level threshold number (Nₜₕ). If, after deducting the number of image pixel data having light levels that fall in the first non-significant dynamic range portion (R_{D1″′}) from the total number of image pixel data between the uppermost and lowermost range limits (R_{1U″′}, R_{2D″′}), the remaining number of image pixel data is larger than a predetermined number, the image processor 122″ then determines a second non-significant dynamic range portion (R_{D2″′}) of the wide input dynamic range of the optical image input between the uppermost and lowermost range limits (R_{1U″′}, R_{2D″′}) and encompassing a second greatest number of consecutive light level coordinates distributed with a number of image pixel data that is below the predetermined light level threshold number (Nₜₕ). Whether or not third to ninth dynamic range portions are to be determined by the image processor 122″ depends on whether the remaining number of image pixel data is larger than the predetermined number. In the example of FIG. 8, because the remaining number of image pixel data between the uppermost and lowermost range limits (R_{1U″′}, R_{2D″′}) after deducting the total number of image pixel data in the first to fourth non-significant dynamic range portions (R_{D1″′}, R_{D2″′}, R_{D3″′}, R_{D4″′}) is not larger than the predetermined number, there is no need to determine the fifth to ninth non-significant dynamic range portions.

Upon determining the different non-significant dynamic range portions (R_{D1″′}, R_{D2″′}, R_{D3″′}, R_{D4″′}, . . . R_{Dn-1″′}), the image processor 122″ is able to determine the range limits of n dynamic range portions, and stores range information associated with the different dynamic range portions in the data storage unit 124″′.

The operation of the fourth preferred embodiment in the output image-generating mode is similar to that of the third preferred embodiment and will not be detailed further for the sake of brevity.

A main advantage arising from the use of the imaging apparatus of this invention resides in that, in the event that back light conditions exist or part of the image is under strong light and another part of the image is under the shade, an output image of relatively good quality can be obtained even without the use of a flash or other light compensating devices. In addition, the output image can be generated using a single optical imaging lens during a single exposure. The imaging apparatus of this invention can thus be used to generate images of a fast moving object.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An imaging method for generating an enhanced optical image of a scene, comprising the steps of:
(a) generating at least first and second optical image data corresponding to an optical image input of the scene taken at a single exposure, the optical image input having a wide input dynamic range with at least higher and lower dynamic range portions, the higher dynamic range portion having an upper range limit that serves as an upper range limit of the wide input dynamic range, the lower dynamic range portion having a lower range limit that is lower than the upper range limit of the higher dynamic range portion and that serves as a lower range limit of the wide input dynamic range, the first optical image data having a dynamic range corresponding to the higher dynamic range portion, the second optical image data having a dynamic range corresponding to the lower dynamic range portion; and
(b) combining the first and second optical image data to result in optical image output data corresponding to the enhanced optical image of the scene.

2. The imaging method according to claim 1, wherein the first and second optical image data are generated by an image generating device that includes:
an optical imaging lens for providing the optical image input;
an image sensing unit, coupled to the optical imaging lens, for generating input optical image signals corresponding to the optical image input;
at least first and second video amplifiers coupled to the image sensing unit and configured to process the input optical image signals so as to generate respectively first and second optical image signals, wherein the first optical image signals have a dynamic range corresponding to the higher dynamic range portion, and wherein the second optical image signals have a dynamic range corresponding to the lower dynamic range portion; and
at least first and second analog-to-digital converters coupled respectively to the first and second video amplifiers, the first and second analog-to-digital converters converting the first and second optical image signals so as to obtain the first and second optical image data respectively therefrom.

3. The imaging method according to claim 2, further comprising the step of adjusting bias and gain settings of the first and second video amplifiers in accordance with the range limits of the higher and lower dynamic range portions of the wide input dynamic range.

4. The imaging method according to claim 3, further comprising the steps, prior to adjusting the bias and gain settings of the first and second video amplifiers, of:
determining the higher and lower dynamic range portions of the wide input dynamic range by analyzing light level coordinate distribution of image pixel data that constitute one of the first and second optical image data from the first and second analog-to-digital converters; and
determining the bias and gain settings of the first and second video amplifiers so as to correspond with the range limits of the higher and lower dynamic range portions.

5. The imaging method according to claim 4, wherein, in the step of determining the higher and lower dynamic range portions of the wide input dynamic range:
the upper range limit of the higher dynamic range portion is the largest light level coordinate distributed with a number of the image pixel data that is above a predetermined light level threshold number;
the lower range limit of the lower dynamic range portion is the smallest light level coordinate distributed with a number of the image pixel data that is above the predetermined light level threshold number; and
a lower range limit of the higher dynamic range portion and an upper range limit of the lower dynamic range portion are adjusted until a total number of the image pixel data having light levels that fall in either one of the higher and lower dynamic range portions is greater than a predetermined pixel threshold number.

6. The imaging method according to claim 2, wherein the image sensing unit includes first and second image sensors coupled respectively to the first and second video amplifiers, the imaging method further comprising the step of adjusting integration times of the first and second image sensors, and bias settings of the first and second video amplifiers in accordance with the range limits of the higher and lower dynamic range portions of the wide input dynamic range.

7. The imaging method according to claim 6, further comprising the steps, prior to adjusting the integration times and the bias settings, of:
determining the higher and lower dynamic range portions of the wide input dynamic range by analyzing light level coordinate distribution of image pixel data that constitute one of the first and second optical image data from the first and second analog-to-digital converters; and
determining the integration times and the bias settings so as to correspond with the range limits of the higher and lower dynamic range portions.

8. The imaging method according to claim 7, wherein, in the step of determining the higher and lower dynamic range portions of the wide input dynamic range:
the upper range limit of the higher dynamic range portion is the largest light level coordinate distributed with a number of the image pixel data that is above a predetermined light level threshold number;
the lower range limit of the lower dynamic range portion is the smallest light level coordinate distributed with a number of the image pixel data that is above the predetermined light level threshold number; and
a lower range limit of the higher dynamic range portion and an upper range limit of the lower dynamic range portion are determined by finding a non-significant dynamic range portion of the wide input dynamic range of the optical image input, the non-significant dynamic range portion encompassing a greatest number of consecutive light level coordinates distributed with a number of the image pixel data that is below the predetermined light level threshold number, the lower range limit of the higher dynamic range portion being an upper range limit of the non-significant dynamic range portion, the upper range limit of the lower dynamic range portion being a lower range limit of the non-significant dynamic range portion.

9. The imaging method according to claim 8, wherein, in the step of determining the higher and lower dynamic range portions of the wide input dynamic range, the predetermined light level threshold number is adjusted until a total number of the image pixel data having light levels that fall in either one of the higher and lower dynamic range portions is greater than a predetermined pixel threshold number.

10. The imaging method according to claim 1, further comprising the step of applying neighborhood transform processing to the first and second optical image data prior to step (b).

11. The imaging method according to claim 4, wherein, in the step of determining the higher and lower dynamic range portions of the wide input dynamic range:
the upper range limit of the higher dynamic range portion is the largest light level coordinate distributed with a number of the image pixel data that is above a predetermined light level threshold number;
the lower range limit of the lower dynamic range portion is the smallest light level coordinate distributed with a number of the image pixel data that is above the predetermined light level threshold number;
a lower range limit of the higher dynamic range portion is determined by inspecting successive ones of the light level coordinates in a descending order starting from the upper range limit of the higher dynamic range portion until a light level coordinate distributed with a number of the image pixel data that is below the predetermined light level threshold number is detected; and
an upper range limit of the lower dynamic range portion is determined by inspecting successive ones of the light level coordinates in an ascending order starting from the lower range limit of the lower dynamic range portion until a light level coordinate distributed with a number of the image pixel data that is below the predetermined light level threshold number is detected.

12. An imaging apparatus for generating an enhanced optical image of a scene, comprising:
an image generating device for generating at least first and second optical image data corresponding to an optical image input of the scene taken at a single exposure, the optical image input having a wide input dynamic range with at least higher and lower dynamic range portions, the higher dynamic range portion having an upper range limit that serves as an upper range limit of the wide input dynamic range, the lower dynamic range portion having a lower range limit that is lower than the upper range limit of the higher dynamic range portion and that serves as a lower range limit of the wide input dynamic range, the first optical image data having a dynamic range corresponding to the higher dynamic range portion, the second optical image data having a dynamic range corresponding to the lower dynamic range portion; and
an image combining device, coupled to the image generating device, for combining the first and second optical image data to result in optical image output data corresponding to the enhanced optical image of the scene.

13. The imaging apparatus according to claim 12, wherein the image generating device comprises:
an optical imaging lens for providing the optical image input;
an image sensing unit, coupled to the optical imaging lens, for generating input optical image signals corresponding to the optical image input;
at least first and second video amplifiers coupled to the image sensing unit and configured to process the input optical image signals so as to generate respectively first and second optical image signals, wherein the first optical image signals have a dynamic range corresponding to the higher dynamic range portion, and the second optical image signals have a dynamic range corresponding to the lower dynamic range portion; and
at least first and second analog-to-digital converters coupled respectively to the first and second video amplifiers, the first and second analog-to-digital converters converting the first and second optical image signals so as to obtain the first and second optical image data respectively therefrom.

14. The imaging apparatus according to claim 13, further comprising a control device, coupled to the first and second video amplifiers, for adjusting bias and gain settings of the first and second video amplifiers in accordance with the range limits of the higher and lower dynamic range portions of the wide input dynamic range.

15. The imaging apparatus according to claim 14, wherein the control device is further coupled to one of the first and second analog-to-digital converters, and determines the higher and lower dynamic range portions of the wide input dynamic range so as to determine the bias and gain settings of the first and second video amplifiers by analyzing light level coordinate distribution of image pixel data that constitute one of the first and second optical image data from said one of the first and second analog-to-digital converters.

16. The imaging apparatus according to claim 15, wherein:
the upper range limit of the higher dynamic range portion is the largest light level coordinate distributed with a number of the image pixel data that is above a predetermined light level threshold number, and the lower range limit of the lower dynamic range portion is the smallest light level coordinate distributed with a number of the image pixel data that is above the predetermined light level threshold number;
the control device adjusting a lower range limit of the higher dynamic range portion and an upper range limit of the lower dynamic range portion until a total number of the image pixel data having light levels that fall in either one of the higher and lower dynamic range portions is greater than a predetermined pixel threshold number.

17. The imaging apparatus according to claim 15, wherein the control device includes:
an image processor coupled to the first and second video amplifiers and to said one of the first and second analog-to-digital converters;
a data storage unit, coupled to the image processor, for storing range information of the higher and lower dynamic range portions of the wide input dynamic range therein; and
a timing controller, coupled to the image processor and the image sensing unit, for controlling integration time of the image sensing unit.

18. The imaging apparatus according to claim 13, wherein the image generating device further includes first and second image buffer units, coupled to the image combining device and to a respective one of the first and second analog-to-digital converters, for storing the first and second optical image data therein, respectively.

19. The imaging apparatus according to claim 18, wherein each of said first and second image buffer units is a line buffer.

20. The imaging apparatus according to claim 13, wherein the image sensing unit includes first and second image sensors coupled respectively to the first and second video amplifiers, the imaging apparatus further comprising a control device, coupled to the first and second image sensors and the first and second video amplifiers, for adjusting integration times of the first and second image sensors, and bias settings of the first and second video amplifiers in accordance with the range limits of the higher and lower dynamic range portions of the wide input dynamic range.

21. The imaging apparatus according to claim 20, wherein the image generating device further includes an image splitter, disposed between the optical imaging lens and the first and second image sensors, for splitting the optical image input and for providing split optical image inputs to the first and second image sensors, respectively.

22. The imaging apparatus according to claim 20, wherein the control device is further coupled to one of the first and second analog-to-digital converters, and determines the higher and lower dynamic range portions of the wide input dynamic range so as to determine the integration times and the bias settings by analyzing light level coordinate distribution of image pixel data that constitute one of the first and second optical image data from said one of the first and second analog-to-digital converters.

23. The imaging apparatus according to claim 22, wherein:
the upper range limit of the higher dynamic range portion is the largest light level coordinate distributed with a number of the image pixel data that is above a predetermined light level threshold number, and the lower range limit of the lower dynamic range portion is the smallest light level coordinate distributed with a number of the image pixel data that is above the predetermined light level threshold number;
the control device further determining a lower range limit of the higher dynamic range portion and an upper range limit of the lower dynamic range portion by finding a non-significant dynamic range portion of the wide input dynamic range of the optical image input, the non-significant dynamic range portion encompassing a greatest number of consecutive light level coordinates distributed with a number of the image pixel data that is below the predetermined light level threshold number, the lower range limit of the higher dynamic range portion being an upper range limit of the non-significant dynamic range portion, the upper range limit of the lower dynamic range portion being a lower range limit of the non-significant dynamic range portion.

24. The imaging apparatus according to claim 23, wherein the control device adjusts the predetermined light level threshold number until a total number of the image pixel data having light levels that fall in either one of the higher and lower dynamic range portions is greater than a predetermined pixel threshold number.

25. The imaging apparatus according to claim 12, wherein the image generating device includes neighborhood transform means for applying neighborhood transform processing to the first and second optical image data prior to reception by the image combining device.

26. The imaging apparatus according to claim 25, wherein the image generating device further includes first and second image buffer units, coupled to the image combining device and the neighborhood transform means, for storing the first and second optical image data therein, respectively.

27. The imaging apparatus according to claim 26, wherein each of the first and second image buffer units is a line buffer.

28. The imaging apparatus according to claim 22, wherein the control device includes:
an image processor coupled to the first and second video amplifiers and to said one of the first and second analog-to-digital converters;
a data storage unit, coupled to the image processor, for storing range information of the higher and lower dynamic range portions of the wide input dynamic range therein; and
a timing controller, coupled to the image processor and the first and second image sensors, for controlling the integration times of the first and second image sensors.

29. The imaging apparatus according to claim 15, wherein the control device is further coupled to the image combining device so as to provide range information of the higher and lower dynamic range portions of the wide input dynamic range thereto, the optical image output data including attribute information to permit reconstruction of the first and second optical image data therefrom.

30. The imaging apparatus according to claim 15, wherein:
the upper range limit of the higher dynamic range portion is the largest light level coordinate distributed with a number of the image pixel data that is above a predetermined light level threshold number, and the lower range limit of the lower dynamic range portion is the smallest light level coordinate distributed with a number of the image pixel data that is above the predetermined light level threshold number;
the control device determining a lower range limit of the higher dynamic range portion by inspecting successive ones of the light level coordinates in a descending order starting from the upper range limit of the higher dynamic range portion until a light level coordinate distributed with a number of the image pixel data that is below the predetermined light level threshold number is detected;
the control device further determining an upper range limit of the lower dynamic range portion by inspecting successive ones of the light level coordinates in an ascending order starting from the lower range limit of the lower dynamic range portion until a light level coordinate distributed with a number of the image pixel data that is below the predetermined light level threshold number is detected.

31. An imaging method for generating an enhanced optical image of a scene, comprising the steps of:
(a) generating input optical image signals by sensing an optical image input of the scene at a single exposure, the optical image input having a wide input dynamic range with a plurality of dynamic range portions;
(b) processing the input optical image signals to obtain a plurality of optical image data during the single exposure, the optical image data having dynamic ranges that correspond respectively to the dynamic range portions; and
(c) combining the optical image data to result in optical image output data corresponding to the enhanced optical image of the scene.

32. The imaging method according to claim 31, wherein the input optical image signals are processed by a plurality of video amplifiers in step (b), the imaging method further comprising the step of adjusting bias and gain settings of the video amplifiers in accordance with range limits of the dynamic range portions of the wide input dynamic range.

33. The imaging method according to claim 32, further comprising the steps, prior to adjusting the bias and gain settings of the video amplifiers, of:
segregating the wide input dynamic range into the dynamic range portions by analyzing light level coordinate distribution of image pixel data that constitute one of the optical image data; and
determining the bias and gain settings of the video amplifiers so as to correspond with range limits of the dynamic range portions.

34. The imaging method according to claim 33, wherein, in the step of segregating the wide input dynamic range into the dynamic range portions, the number and the range limits of the dynamic range portions are determined such that a total number of the image pixel data having light levels that fall in any one of the dynamic range portions is greater than a predetermined pixel threshold number.

35. The imaging method according to claim 31, further comprising the step of applying neighborhood transform processing to the optical image data prior to step (c).

36. An imaging apparatus for generating an enhanced optical image of a scene, comprising:
an image generating device including
an image sensing unit adapted to sense an optical image input of the scene at a single exposure and to generate input optical image signals corresponding to the optical image input sensed thereby, the optical image input having a wide input dynamic range with a plurality of dynamic range portions,
a plurality of video amplifiers coupled to the image sensing unit, and
a plurality of analog-to-digital converters coupled respectively to the video amplifiers,
the video amplifiers and the analog-to-digital converters cooperatively processing the input optical image signals to obtain a plurality of optical image data during the single exposure, the optical image data having dynamic ranges that correspond respectively to the dynamic range portions; and
an image combining device, coupled to the image generating device, for combining the optical image data to result in optical image output data corresponding to the enhanced optical image of the scene.

37. The imaging apparatus according to claim 36, further comprising a control device, coupled to the video amplifiers, for adjusting bias and gain settings of the video amplifiers in accordance with range limits of the dynamic range portions of the wide input dynamic range.

38. The imaging apparatus according to claim 37, wherein the control device is further coupled to one of the analog-to-digital converters, the control device segregating the wide input dynamic range into the dynamic range portions by analyzing light level coordinate distribution of image pixel data that constitute one of the optical image data from said one of the analog-to-digital converters, and determining the bias and gain settings of the video amplifiers in accordance with range limits of the dynamic range portions.

39. The imaging apparatus according to claim 38, wherein the control device determines the number and the range limits of the dynamic range portions such that a total number of the image pixel data having light levels that fall in any one of the dynamic range portions is greater than a predetermined pixel threshold number.

40. The imaging apparatus according to claim 38, wherein the control device includes:
an image processor coupled to the video amplifiers and said one of the analog-to-digital converters;
a data storage unit, coupled to the image processor, for storing range information of the dynamic range portions of the wide input dynamic range therein; and
a timing controller, coupled to the image processor and the image sensing unit, for controlling integration time of the image sensing unit.

41. The imaging apparatus according to claim 36, wherein the image generating device further includes a plurality of image buffer units, coupled to the image combining device and to a respective one of the analog-to-digital converters, for storing the optical image data therein, respectively.

42. The imaging apparatus according to claim 41, wherein each of the image buffer units is a line buffer.

43. The imaging apparatus according to claim 36, wherein the image generating device further includes neighborhood transform means for applying neighborhood transform processing to the optical image data prior to reception by the image combining device.

44. The imaging apparatus according to claim 43, wherein the image generating device further includes a plurality of image buffer units, coupled to the image combining device and the neighborhood transform means, for storing the optical image data therein, respectively.

45. The imaging apparatus according to claim 44, wherein each of the image buffer units is a line buffer.

46. The imaging apparatus according to claim 38, wherein the control device is further coupled to the image combining device so as to provide range information of the dynamic range portions of the wide input dynamic range thereto, the optical image output data including attribute information to permit reconstruction of the optical image data therefrom.
